(19) United States
(12) Patent Application Publication
(10) Pub. No.: US 2009/0310823 A1
(43) Pub. Date: Dec. 17, 2009

(54) Object tracking method using spatial-color statistical model

(75) Inventors: Der-Chun Cherng, Chung-Ho (TW); Chih-Hao Chang, Chung-Ho (TW)

Correspondence Address: LIU & LIU, 444 S. FLOWER STREET SUITE 1750, LOS ANGELES, CA, 90071, US

(73) Assignee: VATICS, INC.

(21) Appl. No.: 12/456,212

(22) Filed: Jun. 11, 2009

(30) Foreign Application Priority Data
Jun. 11, 2008 (TW) 097121630

(51) Int. Cl. G06K 9/00

(52) U.S. Cl. 382/103

(57) ABSTRACT

An object tracking method utilizing spatial-color statistical models is used for tracking an object in different frames. A first object is extracted from a first frame and a second object is extracted from a second frame. The first object is divided into several first blocks and the second object is divided into several second blocks according to pixel parameters of each pixel within the first object and the second object. The comparison between the first blocks and the second blocks is made to find the corresponding relation therebetween. The second object is identified as the first object according to the corresponding relation.

### FIELD OF THE INVENTION

The present invention relates to an object tracking method, and more particularly to an object tracking method using spatial-color statistical model.

### BACKGROUND OF THE INVENTION

For safety purpose, intelligent video surveillance system is developed rapidly in recent years. There have been many surveillance systems applied to our surrounding environments, such as airports, train stations, shopping malls, and even private residential areas where tight or great security is required. Intelligent video surveillance systems can identify objects within the frames. For monitoring various events in real time, e.g. motion detection, tracking objects within frames is a necessary procedure, but the accuracy is somewhat unsatisfactory.

The feature used for tracking moving objects includes color, bounding box (position and size), etc. An appearance model is established by collecting the feature of object. After comparing the appearance model within different frames, the relation between the position of the object and time depicts the moving track.

Some object tracking methods have been proposed, e.g. in U.S. Pat. No. 6,574,353, U.S. Pat. No. 6,226,388, U.S. Pat. No. 5,845,009 and U.S. Pat. No. 6,674,877, incorporated herein for reference. In a non-segmentation based approach, templates are established manually to track objects by template matching. This approach, however, cannot be performed automatically. In a video segmentation based approach, objects are extracted from frames. Then, the pixels belonging to one object are assigned with unique label. According to the assigned labels, bounding boxes are obtained.

To identify an object, a color statistical model is the most widely used model. The color values in the bounding box are analyzed to obtain probability distributions of color parameters including R, G, B in the bounding box. These probability distributions can be expressed by distribution model, for example, Gaussian distribution. The color probability distributions in the bounding box are simulated with a mixture of Gaussian models. Hence, the color probability distributions can be easily expressed by parameters (average μ and variance σ²) defining the Gaussian models. The memory required for recording the parameters is very limited. When two bounding boxes in different masks have similar distribution parameters, they are considered as the same object.

Referring to FIG. 1, two objects 102 and 104 corresponding to bounding boxes 106 and 108 are shown in the binary mask 100. When the two objects 102 and 104 are close to each other, even are touching in the later binary mask 120, there is only one bounding box 126 obtained. Since the color probability distributions of the bounding boxes 106, 108 and 126 are different, the video surveillance system wrongly supposes that two objects 102 and 104 in the frame 100 disappear and a new object including objects 102 and 104 enters the frame. Hence, object tracking is no longer accurate and the performance of the video surveillance system is adversely affected.

Therefore, there is a need of providing an efficient object tracking method, which can accurately identify objects especially when there is interaction between multiple objects.

### SUMMARY OF THE INVENTION

The present invention provides an object tracking method using spatial-color statistical model. The object tracking method can track an object in different frames. A first object extracted from a first frame and a second object extracted from a second frame are compared according to the following steps. At first, the first object and the second object are divided into several first blocks and several second blocks according to pixel parameters of each pixel within the first object and the second object. The first blocks are compared with the second blocks to find the corresponding relation therebetween. The second object is identified as the first object according to the corresponding relation.

In an embodiment, the pixel parameters include at least one color parameter such as (R, G, B) value and at least one position parameter such as (X, Y) coordinate. The spatial-color statistical model is probability distribution, Gaussian distribution for example.

A method for dividing a plurality of pixels of an object into a plurality of blocks is also provided. At first, a plurality of spatial-color statistical models corresponding to the blocks are established. Then, pixel parameters of each pixel of the object are compared with the spatial-color statistical models. If the pixel parameters of one pixel substantially fit a specific spatial-color statistical model, the pixel participates the block corresponding to the specific spatial-color statistical model and the spatial-color statistical model is updated to add the factor relating to the pixel.

A method for constructing a bounding box of an object is further provided. The object is divided into several blocks. If one block includes a portion of other object, the block is discarded. The remained blocks are combined to generate a bounding box of the object.

### BRIEF DESCRIPTION OF THE DRAWINGS

The above contents of the present invention will become more readily apparent to those ordinarily skilled in the art after reviewing the following detailed description and accompanying drawings, in which:

FIG. 1 schematically illustrates the conventional object tracking method for multiple objects;

FIG. 2 is a flowchart illustrating an object tracking method according to a preferred embodiment of the present invention;

FIG. 3 is a flowchart illustrating the steps of dividing object into blocks based on statistical model according to the present invention;

FIG. 4 is a flowchart illustrating another object tracking method according to the present invention; and

FIGS. 5A and 5B schematically illustrate the object tracking method for tracking multiple objects according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

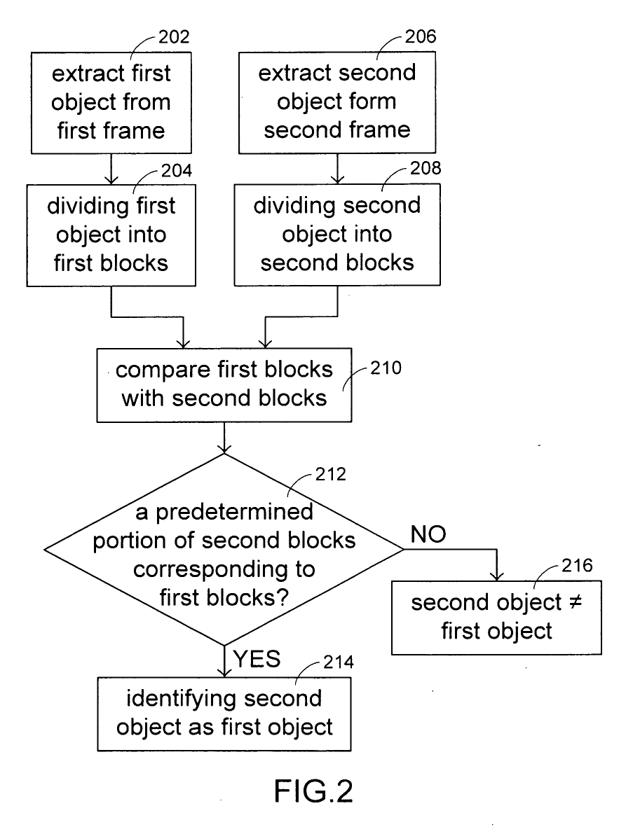

Before tracking an object in different frames, the object should be extracted from the frames. At first, a binary mask obtained by an adaptive background subtraction specifies whether a pixel belongs to the background or foreground. The foreground pixels are analyzed to get connected components. Connected component labeling algorithm is performed to group connected pixels and assigning a unique label for the connected pixels to extract the object. Please refer to FIG. 2, a flowchart illustrating an object tracking method according to a preferred embodiment of the present invention. At steps 202 and 206, two objects are extracted from two frames. In this embodiment, the first frame is earlier than the second frame. The object tracking method can judge whether the two objects are substantially the same object but in different forms. At steps 204 and 208, the two objects are divided into several first blocks and second blocks, respectively. The dividing steps are performed based on features of the objects. For example, adjacent pixels with similar color values, brightness, or color saturation may be grouped in one block. Then, the object tracking method compares the first blocks with the second blocks at step 210. If two blocks have similar features, the two blocks are considered as corresponding block to each other. At step 212, if a great portion of the second blocks find their corresponding first blocks, it is determined, at step 214, that the second object is substantially the first object. Otherwise, at step 216, it is determined that the second object is not the first object. It is not necessary that all the second blocks find their corresponding first blocks. A predetermined ratio is enough to judge that the second object is substantially the first object. It is especially practical when the object suddenly changes its from. For example, in case that a man suddenly sits down does not affect the tracking since his upper portion above the waist can match the features of the blocks extracted from the previous frame.

In one embodiment, dividing the object into several blocks is performed by establishing statistical models of the blocks, especially using spatial-color statistical model. It is assumed that each pixel has three color parameters (R, G, B) and two position parameters (X, Y), which form a five-dimensional space. Each block can be expressed by a probability distribution constructed by the pixels within the block. In this embodiment, Gaussian distribution is taken for example to explain the establishment of the blocks. The representative value of Gaussian distribution is average μ. In a mathematic form, a pixel p is expressed as:

p=[Rₚ, G_{P}, Bₚ, Xₚ, Yₚ]^{T} (1)

And object P is a set of n pixels:

P{p₁, p₂, p₃, . . . , pₙ} (2)

The overall probability distribution of object P can be simulated by K probability distributions:

$$f ( P ) = {\sum }_{i = 1}^{K} {α}_{i} \times {g}_{i} ( p ; {μ}_{i} , {σ}_{i}^{2} ) \qquad ( 3 )$$

Wherein αᵢ is mixing parameter meeting

$${\sum }_{i = 1}^{K} {α}_{i} = 1.$$

If parameters (R, G, B, X, Y) of a pixel are close to an overall Gaussian distribution average μᵢ of a block, the pixel is considered as one member of the block. Accordingly, for each pixel, the system finds one of the overall Gaussian distribution average μᵢ which is closest to the pixel parameter pⱼ:

i=min[pⱼ−μᵢ]⁻¹ (4)

Now, for the found i, a determination is made to judge whether the difference between the pixel parameter and the Gaussian distribution average is small enough. A threshold value is predetermined for the comparison. If the difference is less than the threshold value, the pixel is determined to belong to the corresponding block. Then, the corresponding overall Gaussian distribution is updated to include the pixel based on the following equations:

μᵢ^{′}=μᵢ+ω·(p−μᵢ) (5)

σᵢ^{2′}=σᵢ²+ω·[(p−μᵢ)·(p−μᵢ)−σᵢ²] (6)

Please note that the pixel parameters include both color parameters and position parameters. Hence, adjacent pixels with similar color are grouped in one block. The blocks are more suitable than the whole object for later analysis.

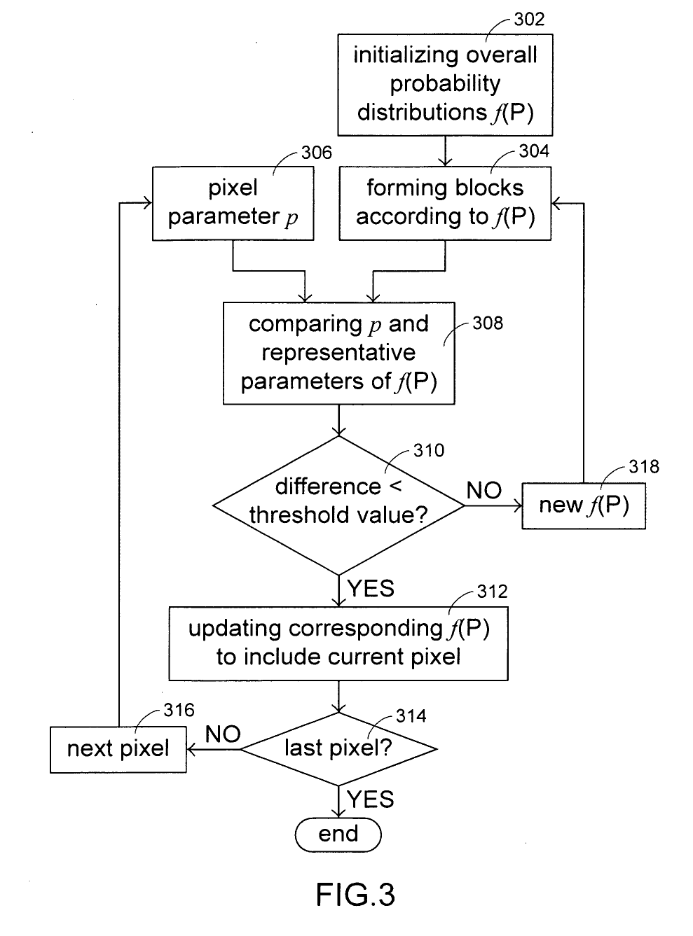

Please refer to FIG. 3 illustrating the steps of dividing object into blocks based on statistical model as described above. At first, at step 302, probability distributions are initialized. In this embodiment, each probability distribution corresponds to a block. Hence, the final number of the probability distributions is the number of the divided blocks. The system forms blocks according to the probability distributions at step 304. At this time, the current pixel is waiting the classification action to join one or few of the blocks. At step 306, the pixel parameter(s) is inputted to the system and compared with the representative parameters of the probability distributions at step 308. If the probability distribution is Gaussian distribution, the representative parameter should be average μ. The differences are compared with a predetermined threshold value at step 310 to determine whether it is proper for classifying the current pixel into the block(s) corresponding to the probability distribution(s). If the difference is less than the threshold value, it means that the feature of the pixel is similar to the corresponding block. Hence, the corresponding probability distribution should be updated to include the current pixel at step 312. The updating can refer to the equations (5) and (6). If no difference is less than the threshold value, it means that no block has similar feature to the current pixel. Thus, a new probability distribution is established at step 318. Accordingly, a new block is formed at step 304.

These steps repeat till all the pixels are classified into proper blocks (steps 314 and 316). According to the present invention, the extracted object can be easily and automatically divided into blocks for further analysis or tracking.

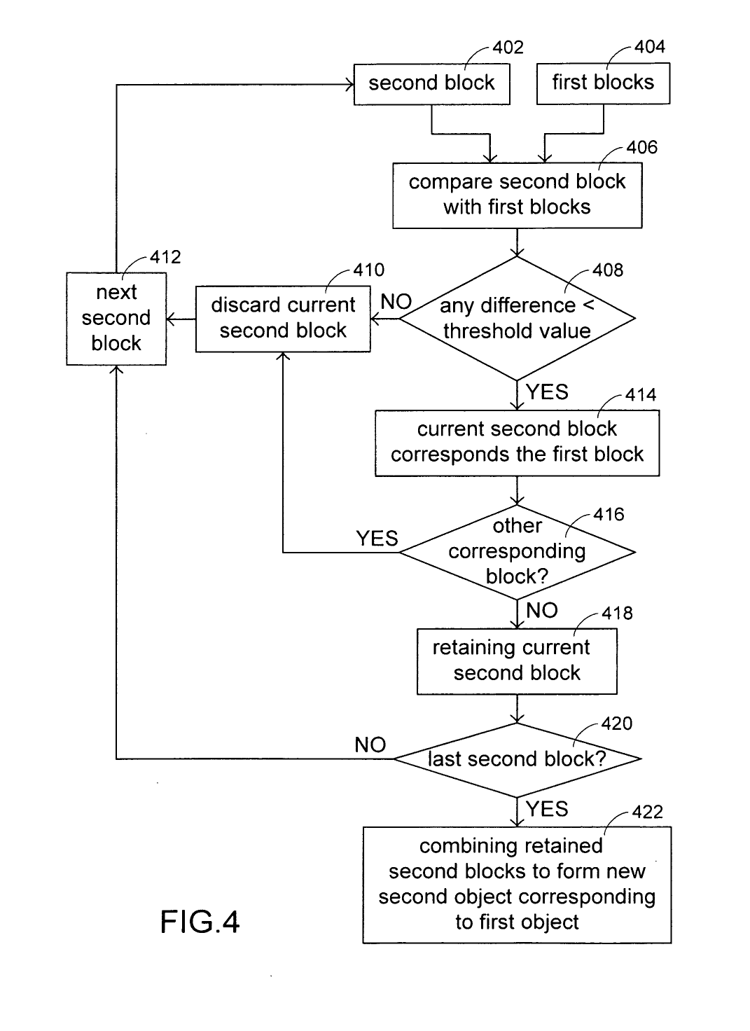

Please refer to FIG. 4, a flowchart illustrating another object tracking method according to the present invention. In this embodiment, one object in different frames is tracked. The first object is extracted from an earlier frame and the second object is extracted from a later frame. The second object includes other object interfering the first object. It is desired to reconstruct a bounding box of the second object to remove the other object. The first object and second object are divided into first blocks and second blocks. At step 406, the method compares the current second block received from step 402 with the first blocks received from step 404. For the sake of convenience, representative parameters of probability distributions corresponding to the blocks may be adopted for the comparison. If the probability distribution is Gaussian distribution, the representative parameter may be average μ. If the difference between the current second block and each of the first blocks is not less than a predetermined threshold value (step 408), it means that the current second block has no corresponding first block. In other words, the current second block may belong to other object. Hence, the current second block is discarded (step 410) and a next second block is selected to repeat the procedure (step 412).

If a difference between the current second block and a particular first block is less than the predetermined threshold value, the current second block is considered as corresponding to the particular first block (step 414). However, if the current second block corresponds more than one blocks, the current second block may include block of other object (step 416). Therefore, the current second block is also discarded (step 410). Otherwise, one-to-one corresponding relation is established between the second blocks and the first blocks (step 418). The steps repeat till all the second blocks have been compared (step 420 and 412). The remained second blocks are combined to construct a bounding box of the second object which corresponds to the first object in the earlier frame (step 422) so as to achieve object tracking of the first object in different frames.

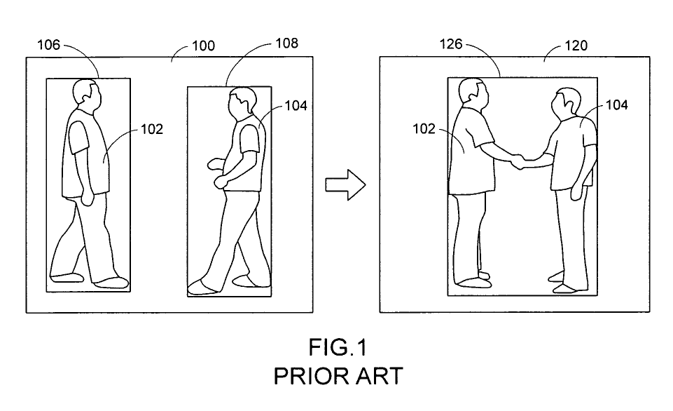

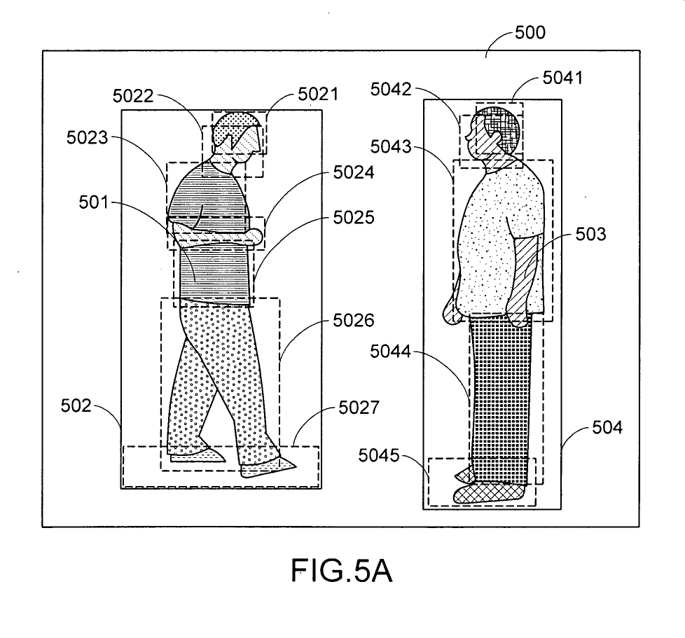

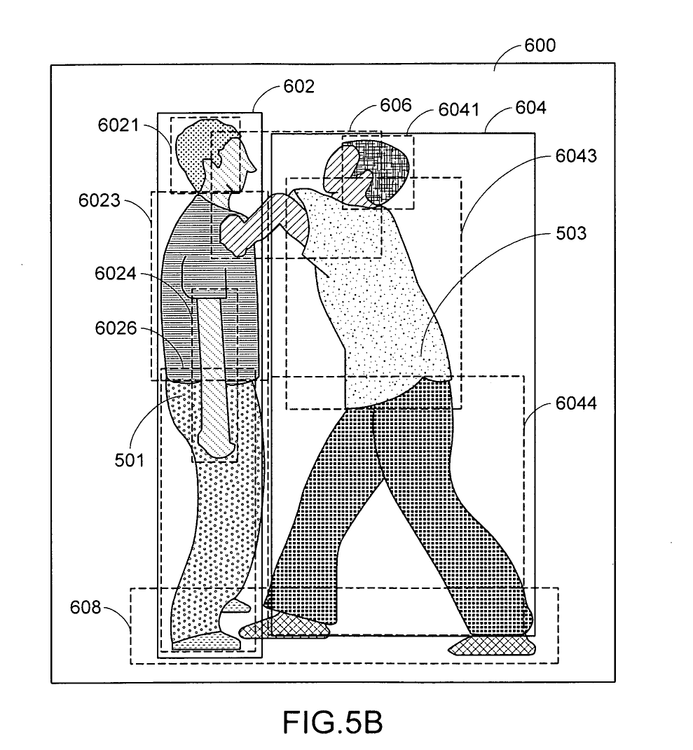

The above-described procedure is applied to the example shown in FIG. 1. Please refer to FIGS. 5A and 5B illustrating the object tracking method of FIG. 4. In the earlier frame 500, there are two separate objects 501 and 503. The object 501 has a bounding box 502 and is divided into blocks 5021-5027; while the object 503 has a bounding box 504 and is divided into blocks 5041-5045 according to the statistical model and procedure with reference to FIG. 3.

In the later frame 600, the two objects 501 and 503 touches each other. In the prior art, one bounding box is generated and the bounding box includes the two objects 501 and 503. According to the present invention, for analyzing the frame 600, the objects 501 and 502 are automatically divided into blocks 6021, 6023, 6024, 6026, 6041, 6043, 6044, 606 and 608. According to the procedure of FIG. 4, the method compares the features of the blocks, a one-to-one corresponding relation is established as follows:

| | | | |
|---|---|---|---|
| 6021-5021 | 6023-5023 | 6024-5024 | 6026-5026 |
| 6041-5041 | 6043-5043 | 6044-5044 | |

Besides, the block 606 corresponds to both the block 5022 and the block 5042 (step 416). Therefore, the block 606 is discarded at step 410. Similarly, since the block 608 corresponds to both the block 5027 and the block 5045, the block 608 is also discarded. The remained blocks can construct the object bounding box. For example, the bounding box 602 is composed of blocks 6021, 6023, 6024 and 6026; while the bounding box 604 is composed of blocks 6041, 6043 and 6044. Accordingly, even though multiple objects interact with each other, the objects can be accurately tracked according to the present invention.

From the above description, the present object tracking method utilizes the concept of breaking the whole into parts to efficiently exhibit the features of blocks instead of the whole object. This method is particularly practical for tracking multiple objects with interaction. Besides, a spatial-color statistical model is used to focus on features locally. It is to be noted that other statistical models may be useful and the statistical model does not limited to Gaussian distribution or normal distribution. The interference caused by other object can be removed by discarding the interfered blocks so as to achieve more accurate tracking.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An object tracking method applied to analyzing a first object extracted from a first frame and a second object extracted from a second frame for identifying the second object with the first object, comprising steps of:
dividing the first object into a plurality of first blocks and dividing the second object into a plurality of second blocks according to pixel parameters within the first object and the second object;
comparing the second blocks with the first blocks; and
determining whether the second object is the first object according to the comparing result.

2. The object tracking method according to claim 1 wherein the pixel parameters include at least one color parameter and at least one position parameter.

3. The object tracking method according to claim 2 wherein the color parameter includes red value, green value and blue value of a pixel, and the position parameter includes X coordinate value and Y coordinate value of the pixel.

4. The object tracking method according to claim 1 wherein the first object and the second object are divided by establishing a statistical model according to the pixel parameters, comprising steps of:
providing a plurality of probability distributions each of which corresponds to one of the first and second blocks;
comparing the pixel parameters of each pixel of the first object and the second object with the probability distributions; and
classifying a selected pixel into a selected one of the blocks when the difference between the pixel parameters of the selected pixel and a representative parameter of one of the probability distribution corresponding to the selected block is less than a first threshold value.

5. The object tracking method according to claim 4 wherein the probability distribution is Gaussian distribution and the representative parameter is an average of the Gaussian distribution.

6. The object tracking method according to claim 4, further comprising a step of updating the corresponding probability distribution according to the pixel parameters of the selected pixel to have the selected block comprise the selected pixel.

7. The object tracking method according to claim 4 wherein the step of comparing the second blocks with the first blocks is executed by comparing the representative parameters of the probability distributions corresponding to the first blocks and the second blocks.

8. The object tracking method according to claim 7 wherein one of the first block corresponds to one of the second block when a difference between the representative parameters of the probability distributions corresponding to the one first block and the one second block is less than a second threshold value.

9. The object tracking method according to claim 1 wherein the second object is identified with the first object when a predetermined portion of the second blocks have corresponding first blocks.

10. The object tracking method according to claim 1, further comprising steps of:
discarding one of the second blocks when the second block does not correspond to any one of the first blocks;
discarding one of the second blocks when the second block correspond to more than one first blocks; and
combining remained second blocks to construct a bounding box.

11. A method for dividing a plurality of pixels of an object into a plurality of blocks, comprising steps of:
establishing a plurality of spatial-color statistical models corresponding to the blocks;
comparing pixel parameters of each pixel of the object with the spatial-color statistical models, the pixel parameters comprising at least one color parameter and at least one position parameter; and
classifying a selected pixel into a selected one of the blocks according to the comparing result.

12. The method according to claim 11 wherein the color parameter includes red value, green value and blue value of the pixel, and the position parameter includes X coordinate value and Y coordinate value of the pixel.

13. The method according to claim 12 wherein the spatial-color statistical models are probability distributions.

14. The method according to claim 13 wherein the selected pixel is classifying into the selected block when the difference between the pixel parameters of the selected pixel and a representative parameter of one of the probability distribution corresponding to the selected block is less than a threshold value.

15. The method according to claim 14, further comprising a step of updating the corresponding probability distribution according to the pixel parameters of the selected pixel to have the selected block comprise the selected pixel.

16. The method according to claim 15 wherein the probability distribution is Gaussian distribution and the representative parameter is an average of the Gaussian distribution.

17. The method according to claim 16 wherein the Gaussian distribution is updated by the following equations:
μᵢ^{′}=μᵢ+ω·(p−μᵢ)
σᵢ^{2′}=σᵢ²+ω·[p−μᵢ)·(p−μᵢ)−σᵢ²]
wherein p is the pixel parameter of the selected pixel, μ is the average of the Gaussian distribution, and σᵢ² is a variance of the Gaussian distribution.

18. A method for constructing a bounding box of a first object provided by changing appearance of a second object, comprising steps of:
dividing the first object into a plurality of first blocks and dividing the second object into a plurality of second blocks according to pixel parameters of each pixel within the first object and the second object;
comparing the first blocks with the second blocks;
discarding one of the first blocks when the first block does not correspond to any one of the second blocks;
discarding one of the first blocks when the first block corresponds to more than one second blocks; and
combining remained first blocks to construct a bounding box of the first object.

19. The method according to claim 18 wherein the pixel parameters include at least one color parameter and at least one position parameter.

20. The object tracking method according to claim 19 wherein the color parameter includes red value, green value and blue value of the pixel, and the position parameter includes X coordinate value and Y coordinate value of the pixel.
